(19) United States
(12) Patent Application Publication
(10) Pub. No.: US 2011/0235461 A1
(43) Pub. Date: Sep. 29, 2011

(54) FUNCTIONING SECTION OF A HAND BLENDER AND/OR MIXER WITH MULTIPLE ROTATING BLADES

(75) Inventor: Mete GÜRSEL, Istanbul (TR)

(73) Assignee: ERNA-MAS MAKINE TICARET VE SANAYI ANONIM SIRKETI, Istanbul (TR)

(21) Appl. No.: 12/788,737

(22) Filed: May 27, 2010

(30) Foreign Application Priority Data
Mar. 29, 2010 (TR) U 2010 02379

(51) Int. Cl. B01F 15/00

(52) U.S. Cl. 366/129

(57) ABSTRACT

The invention refers to the functioning section of a hand blender and/or a hand mixer having more than one rotating blade enabling users to blend dry and/or liquid food. The functioning section includes a rotating blade, a transmission shaft, a guard surrounding the blade, and transmission/coupling elements. By virtue of more than one rotating blade, it allows the fulfillment of blending, mixing and homogenization procedures of dry and/or liquid food.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The invention refers to the functioning section of a hand blender and/or hand mixer with more than one rotating blade enabling the users to blend dry and/or liquid food. The section includes a rotating blade (1), a transmission shaft (2), a guard (3) surrounding the blade and transmission/coupling elements (4). By virtue of more than one rotating blade (1), it allows the fulfillment of blending, mixing and homogenization procedures of dry and/or liquid food.

2. Description of Related Art Including Information Disclosed Under 37 CFR 1.97 and 37 CFR 1.98

In general, there are currently three types of hand blenders available on the market. First, single unit instruments made of plastic or metal that are run by switching on the engine which drives the shaft that operates the rotating blade at the lower end (FIG. 1-a). Second, instruments which are interconnected in a mechanical order (screwing, spring latch lock, etc.) made of plastic or metal, featuring an engine block and a blade connected to a shaft and a bearing, comprising of a plastic and/or metal body (FIG. 1-b). Third, single-function instruments that could be connected to the motor shaft of any hand blender in the specified mechanical order featuring a rotating blade at the lower section, comprising of a plastic and/or metal body (FIG. 1-c).

The functioning section of hand blenders available in the market is the rotating blade driven by the engine and this functioning section is available in all hand blenders.

### BRIEF SUMMARY OF THE INVENTION

The present invention is the functioning section made of plastic and/or metal including more than one rotating blade (1) driven by a mechanical order instead of a single blade.

### BRIEF DESCRIPTION OF THE SEVERAL VIEWS OF THE DRAWINGS

FIG. 1 shows three schematic views of blender functioning sections in existing systems.

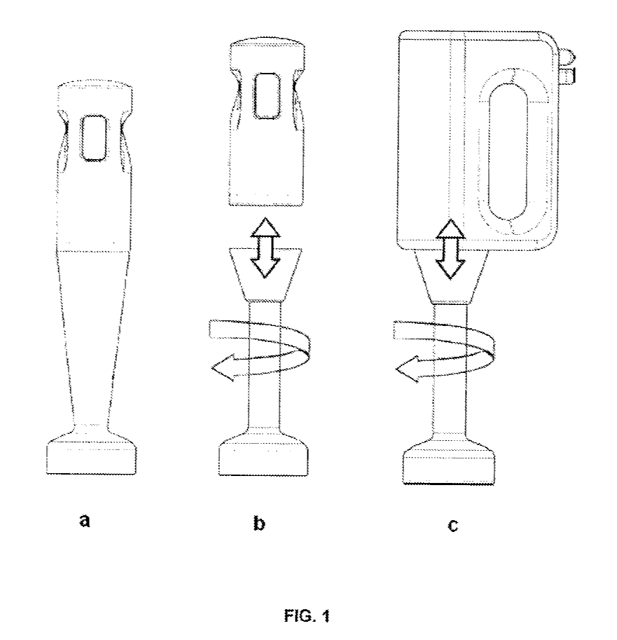

FIG. 2 shows a schematic view of a hand blender of the existing systems.

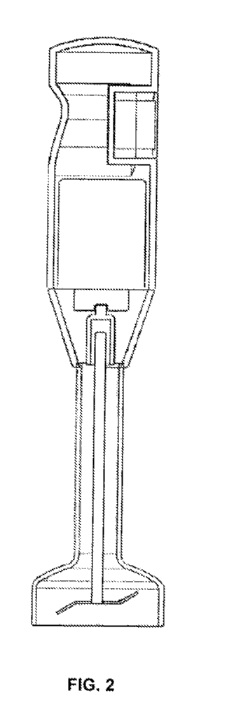

FIG. 3 shows a schematic view of a single-blade hand blender of the existing systems.

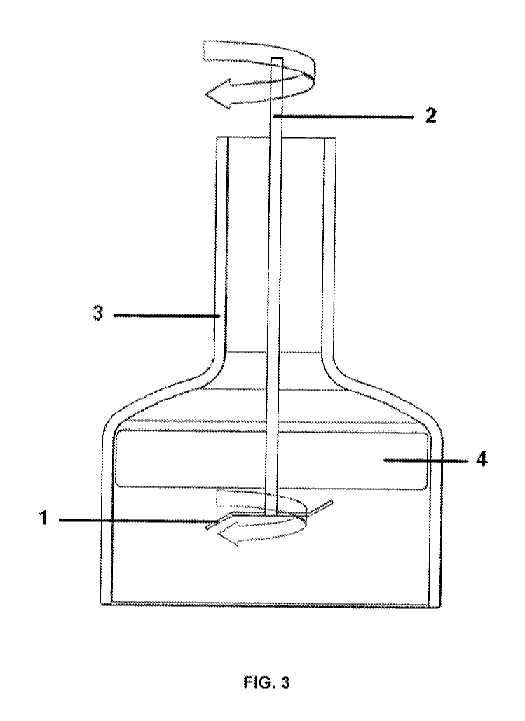

FIG. 4 shows a schematic view of a hand mixer with three rotating blades of the present invention.

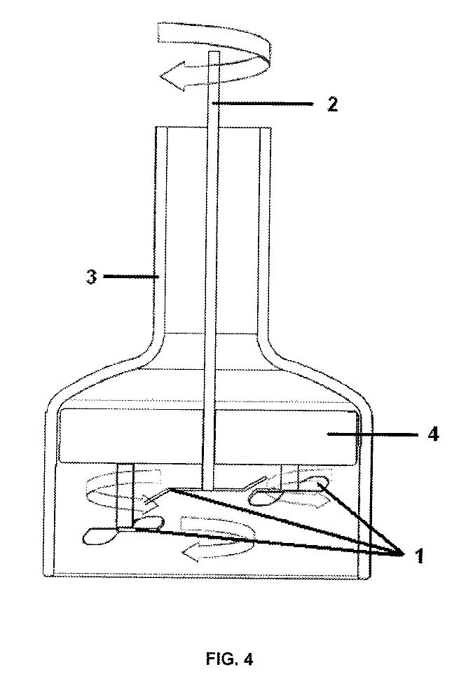

FIG. 5 shows a schematic view of a hand mixer functioning section of the present invention showing the various rotating blades.

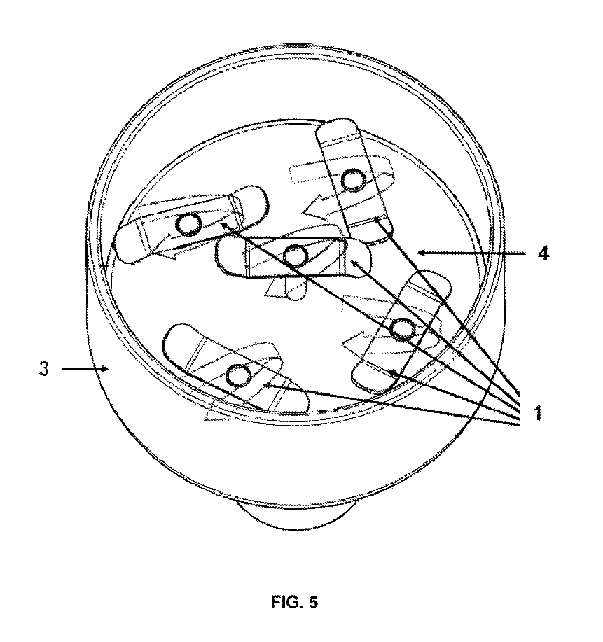

FIG. 6 shows schematic views of the guards of the hand mixer functioning section of the present invention with various apertures or without apertures.

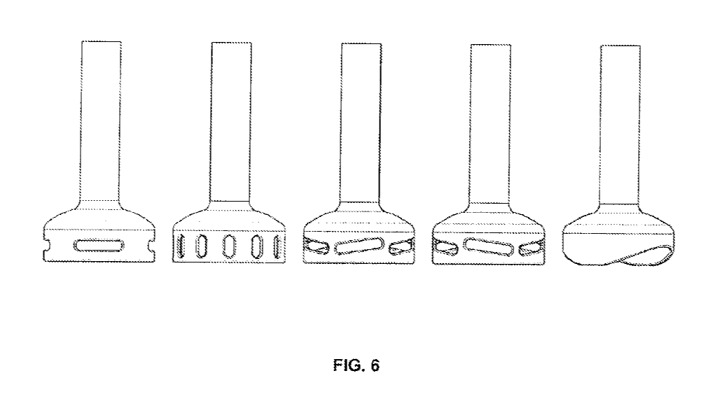

### DETAILED DESCRIPTION OF THE INVENTION

The rotating blades (1) included in the invention feature same or different rotating speeds. The blades (1) are also able to rotate on their own axis and around the functioning section.

In this invention, the number of shafts (2) enabling the rotation of rotating blades (1) is one or more than one.

The invention could be run by locking to any hand mixer engine block or body in a mechanical order. The invention is integrated with the engine shaft.

It is possible to have an aperture above the guard section (3) around the blade and to open this aperture in parallel to the shaft (2) axis or in any angle to this axis. It is also possible not to have any aperture.

The mechanical order driving the blades (1) in the multi blade functioning section is included in the engine block.

1. A functioning section of a hand blender and/or hand mixer has more than one rotating blade enabling the users to blend dry and/or liquid food which is characterized by more than one rotating blade, a transmission shaft and a guard surrounding the blade and transmission/coupling system elements ensuring blending, mixing and homogenization procedures of dry and/or liquid food.

2. The functioning section of claim 1, wherein the blades are rotating blades characterized by same or different rotating speeds.

3. The functioning section of claim 1, wherein one or more than one shaft drives the rotating blades.

4. The functioning section of claim 1 characterized by integrity with the engine block.

5. The functioning section of claim 1 characterized by its ability to be locked to the engine block of any hand blender and/or hand mixer in a mechanical order.

6. The functioning section of claim 1 characterized by its ability to be locked to the mechanical body of any hand mixer in a mechanical order.

7. The functioning section of claim 1 wherein the mechanical setup which drives the blades is included in the engine block.

8. The functioning section of claim 1 characterized by its plastic and/or metal origin.

9. The functioning section of claim 1 wherein the blades have the ability to rotate both around their own axis and around the axis of the functioning section.

10. The functioning section of claim 1, characterized by the aperture option above the guard surrounding the functioning section blades or in parallel to the shaft axis or in any angle of the axis or the option of no apertures.
